(19) United States
(12) Patent Application Publication
(10) Pub. No.: US 2005/0028799 A1
(43) Pub. Date: Feb. 10, 2005

(54) SYSTEM AND METHOD USING ION GAP SENSING FOR OPTIMIZATION OF A MULTI-SPARK EVENT IN A MARINE ENGINE

(76) Inventor: David T. Montgomery, Pleasant Prairie, WI (US)

Correspondence Address: BOMBARDIER RECREATIONAL PRODUCTS INC.;INTELLECTUAL PROPERTY DEPT, PO BOX 230, NORTON, VT, 05907-0230, US

(21) Appl. No.: 10/605,712

(22) Filed: Oct. 21, 2003

Related U.S. Application Data
(60) Provisional application No. 60/481,186, filed on Aug. 6, 2003.

(51) Int. Cl. F02P 9/00

(52) U.S. Cl. 123/596; 123/625

(57) ABSTRACT

A system and method for controlling an ignition system includes an engine having a combustion chamber and a spark plug is disposed within the combustion chamber. An ECU is configured to execute a multi-spark event. The ECU is configured to cause the spark plug to execute the multi-spark event and discontinue the multi-spark event if a conductivity indicative of combustion is detected in the combustion chamber.

### CROSS REFERENCE To RELATED APPLICATIONS

The present invention claims the benefit of U.S. Ser. No. 60/481,186 filed Aug. 6, 2003.

### BACKGROUND OF INVENTION

The present invention relates generally to internal combustion engines, and more particularly, to a system and method of ion gap sensing within a combustion chamber of the engine to provide feedback whereby the feedback may be used to optimize the duration of a multi-spark event.

In general, fuel-injected internal combustion engines include a fuel injector that provides a fine mist of fuel that mixes with combustion generating gases, generally a mixture of fresh air and any remaining exhaust gases, within a cylinder. Ideally, this mixture is compressed and spark ignited.

Certain fuel-injected internal combustion engines have been refined to operate in two combustion modes that can be defined as a stratified operation and a homogenous operation. When the engine is operating at low speeds and/or loads, a stratified operation is generally preferred, in which fuel is introduced into the combustion chamber and spark ignited on injection. In contrast, when the engine is operating at higher engine speeds and/or under higher loads, a homogenous operation is preferred, where the fuel is allowed to hit the piston and intermix more thoroughly with the combustion gases before ignition. Therefore, the homogenous combustion mode is characterized by a generally uniform and relatively rich fuel charge in the combustion chamber. On the other hand, a stratified operating mode is characterized by fluctuations in the fuel and gas mix, or equivalence ratio.

Stratified combustion can include an air/fuel mixture having mainly a lean mixture about a periphery of the combustion chamber surrounding a relatively small layer or pocket of rich mixture near a center of the combustion chamber. In one mode, the rich mixture is initially ignited by firing a spark into the combustion chamber early in the combustion cycle wherein the ignition spreads to the leaner mixture consuming the rest of the leaner mixture in the combustion chamber. However, power requirements while in the stratified mode can require wide fluctuations in the fuel-to-air mixture ratio or equivalence ratio and/or timing. As a result, in stratified combustion mode, it is possible to fire a spark too early, which does not result in combustion taking place.

To overcome this unpredictability of combustion due to fluctuations in the equivalence ratio, multi-strike or multi-spark systems have been developed. Multi-spark systems are used in engines that may have substantial fluctuations in the equivalence ratio at the time combustion is desired, as is common in stratified combustion. While multi-spark systems are typically implemented during stratified combustion to counter the effects of fluctuation in the equivalence ratio, multi-spark engines may also be used in other systems to avoid misfires. By firing multiple sparks into the combustion chamber the probability of efficient combustion is increased. Simply, by sparking multiple times over the combustion cycle, a spark is likely to be provided at a time when the equivalence ratio is ideal for combustion to occur. To implement a multi-spark system, an engine control unit causes the spark plug to spark repeatedly and then discontinues the multi-spark event after a given duration, usually a predetermined time period or number of sparks.

In such known systems, the spark plug may be fired more than needed. That is, firing the spark plug for a fixed time or fixed number of firings, regardless of when combustion takes place, puts undue wear on the spark plug by firing the plug even though combustion has occurred. Further, unless combustion occurs at the very last spark of the multi-spark event, the spark plug is firing after combustion has occurred. However, since the multi-spark event is typically a predetermined length and combustion during the multi-spark event may occur as a result of any spark in the event, combustion may occur well before the multi-spark event is complete. Unless it is know precisely when combustion takes place, such systems always result in more sparks than is necessary, and if it were know when combustion occurs, precisely, multi-spark systems would not be necessary at all.

By sparking multiple times per combustion cycle, the wear and breakdown of the spark plug generating the sparks is increased. A typical spark plug has a known lifetime that can be estimated by a range of sparks that the spark plug can produce. That is, for every spark produced, the spark plug approaches the end of its operational lifetime. Therefore, in a multi-spark system, the operational lifetime of a spark plug is compressed into a shorter duration due to the fact that the spark plug is caused to fire multiple times per combustion cycle. As such, a spark plug in a multi-spark system typically requires maintenance or replacement on a more-frequent basis. This added cost of maintenance or replacement can become particularly cumbersome when aggregated across multiple cylinders and over the lifetime of an engine. Further, the stringent emission standards dictate a minimum life for spark plugs that may be difficult to achieve with conventional plugs in a conventional multi-spark system.

It would therefore be desirable to have a system and method to minimize the number of firings of a multi-spark event to limit the wear on spark plugs within a multi-spark system.

### BRIEF DESCRIPTION OF INVENTION

The present invention provides a system and method of optimizing the duration of a multi-spark event to overcome the aforementioned drawbacks. Specifically, an engine control unit (ECU) determines the current between a pair of electrodes within a combustion chamber of a combustion engine prior to the initiation of a multi-spark event. Then, following the initiation of the multi-spark event, the engine control unit discontinues the multi-spark event if an increase in current between the electrodes, caused by an increase in ion concentration within the combustion chamber and indicative of combustion, is detected. The ECU then stops firing the spark plug after combustion has occurred and unnecessarily firings are avoided.

In accordance with one aspect of the current invention, a system for controlling an ignition system is disclosed that includes an ECU equipped engine having at least one combustion chamber, and a spark plug in operable association with the combustion chamber to allow a multi-spark event. The ECU is configured to commence the multi-spark event, detect combustion, and discontinue the multi-spark event when a certain level of ionization is detected in the at least one combustion chamber.

In accordance with another aspect of the current invention, a method of controlling a multi-spark ignition system is disclosed that includes determining a first ion concentration within a combustion chamber and then firing an ignition spark of a multi-spark event into the combustion chamber. The method includes monitoring subsequent ion concentration within the combustion chamber and disabling subsequent ignition sparks of the multi-spark event if a difference between the first and subsequent ion concentrations is indicative of a fuel ignition.

In accordance with another aspect of the current invention a combustion engine is disclosed that includes a powerhead having a combustion engine, a midsection configured for mounting the outboard motor to a watercraft, and a lower unit powered by the engine to propel the watercraft. The combustion engine also includes at least one combustion chamber and at least one spark plug to execute a multi-spark event. A pair of electrodes are also disposed within the at least one combustion chamber. An ECU is configured to commence the multi-spark event by repeatedly sparking the spark plug and discontinue the multi-spark event if a current indicative of combustion between the pair of electrodes within the combustion chamber is during the multi-spark event.

Various other features, objects and advantages of the present invention will be made apparent from the following detailed description and the drawings.

### BRIEF DESCRIPTION OF DRAWINGS

The drawings illustrate one preferred embodiment presently contemplated for carrying out the invention.

In the drawings:

FIG. 1 is an outboard marine motor incorporating the present invention.

FIG. 2 is a block schematic representation of a fuel delivery and ignition system of the motor shown in FIG. 1.

FIG. 3 is a cross-sectional view of an engine cylinder of an engine shown in FIG. 1.

FIG. 4 is a flow chart setting forth the steps of a process for ion gap sensing for optimizing a multi-spark event within the engine shown in FIG. 1.

### DETAILED DESCRIPTION

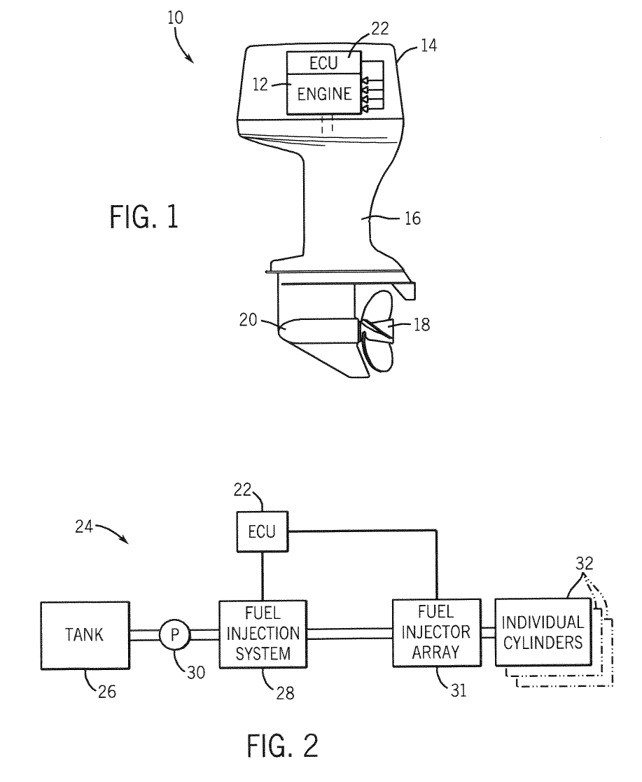

The present invention relates to internal combustion engines, and preferably, those incorporating fuel injection in a spark-ignited gasoline-type engine. In a preferred embodiment, the engine is a two-stroke direct injection engine. FIG. 1 shows an outboard motor 10 having one such engine 12. The engine 12 is housed in a powerhead 14 and supported on a mid-section 16 configured for mounting on the transom of a boat (not shown) in a known conventional manner. An output shaft of the engine 12 is coupled to a drive propeller 18 extending rearwardly of a lower gearcase 20 via the mid-section 16. The engine 12 is controlled by an electronic control unit (ECU) 22. While the present invention is shown in FIG. 1 as being incorporated into an outboard motor, the present invention is equally applicable with many other recreational products such as inboard motors, motorcycles, scooters, snowmobiles, personal watercrafts, lawn maintenance equipment, all-terrain vehicles, as well as any other equipment requiring a power source.

Referring to FIG. 2, a block diagram of an exemplary fuel delivery and ignition system 24 is illustrated for use with the outboard motor 10 of FIG. 1. This particular fuel system employs a single fuel tank 26 (although, multiple fuel supplies are possible) connected to a fuel injection system 28 via a primer bulb 30. The primer bulb 30 supplies fuel to the fuel injector system 28 prior to starting the engine. When operating the engine, the ECU 22 controls the fuel injection system 28 to provide fuel to a fuel injector array 31 that includes one or more fuel injectors in direct communication with one or more cylinders 32 of the engine.

The fuel injection system 28 can include multiple fuel system components such as a fuel pump, pressure regulators, fuel pressure sensors, fuel coolers, etc. A fuel injector array 31 can include a plurality of individual fuel injectors fluidly connected with a delivery fuel rail and a return fuel rail. The number of fuel injectors is dependent on the number of cylinders of the engine. The fuel delivery system 24 is constructed to provide each of a plurality of individual engine cylinders 32 with fuel from the fuel tank 26. Once the fuel is delivered to the individual engine cylinders 32, the ECU 22 causes a spark plug housed in each individual cylinder 32 to begin a multi-spark event, which continues until the ECU determines combustion has occurred within the individual cylinder. In a preferred embodiment, the multi-spark event is part of a stratified combustion method. However, it is contemplated that the present invention may be implemented in conjunction with a multi-spark event for an engine operating in a homogeneous combustion method or, any other combustion scheme.

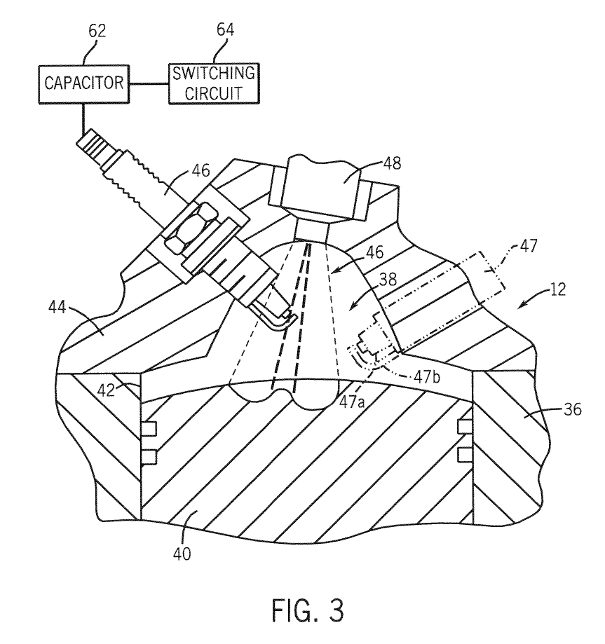

Referring now to FIG. 3, an exemplary individual engine cylinder 34 is shown in cross-section. The cylinder 34 is formed in an engine block 36. A combustion chamber 38 is located in an upper portion of the cylinder 34. The combustion chamber 38 is defined as the space contained between a piston 40, a cylinder wall 42, and a cylinder head 44 mounted on the engine block 36. Disposed within the cylinder head 44 are a fuel injector 48 and a spark plug 46. As will be further described, the fuel injector 48 secured within the cylinder head 44, is position to inject fuel into the combustion chamber 38 whereby a pair of ignition electrodes 45 of the spark plug 36 is positioned within the combustion chamber to generate a spark to ignite the fuel. The spark plug 46 is supplied with power to generate the spark by a capacitor 62. A switching circuit 64 is included to control and switch the capacitor 62. The capacitor 62 is electronically coupled to each of a plurality of cylinders selectively. A pair of auxiliary electrodes 47 (shown in phantom), comprised of electrodes 47a and 47b, may be provided and used for ion sensing, in accordance with the invention, instead of, or in addition to, the electrodes 45 of spark plug 46. The pair of auxiliary electrodes 47 is disposed within the cylinder head 44 such that the pair of auxiliary electrodes 47 is exposed to the combustion chamber 38. Alternatively, the auxiliary electrodes 47 may also include one sandwiched between the head and the head gasket and another between the head gasket and the block.

The piston 40 reciprocates in cylinder 34 thereby changing the volume of the combustion chamber 38. As will be fully described, at or near the lowest point during reciprocation, bottom-dead-center (BDC), an initial ion gap sensing is performed. Simply, the ECU 22 of FIG. 2, energizes a pair of electrodes, separated by an air gap within the combustion chamber 38, FIG. 3, with a voltage potential and determines a current induced by the voltage potential at BDC. This initial ion gap sensing is then used as a threshold for later measurement. As alluded to previously, the pair of electrodes may be the ignition electrodes 45 of spark plug 46, or may be the auxiliary electrodes 47, which are disposed within the combustion chamber 38, distinct from the traditional ignition system. Specifically, in accordance with one embodiment, the pair of electrodes energized is the pair of ignition electrodes 45. However, in accordance with another embodiment, the auxiliary pair of electrodes 47 if included is dedicated to ion gap sensing. As such, any pair of electrodes in the combustion chamber may perform ion gap sensing.

Ion gap sensing is implemented to determine conductivity by detecting the concentration of ionized gases within the combustion chamber 38. Ion gap sensing is accomplished by placing a voltage potential across a pair of electrodes in the combustion chamber 38 and measuring the current that flows between the electrodes. As stated, electrodes can either be the pair of ignition electrodes 45 of the spark plug 46 or another pair of auxiliary electrodes 47. Under a constant voltage potential, the current that flows between the electrodes is proportional to the conductivity of the gas in the combustion chamber. The conductivity of the gas is indicative of the ionization of the combustion gas because the ions are responsible for the transportation of the charge across the gap between the electrodes. The ions are produced from two sources, both of which are indicative of combustion. First, when the molecules of the injected fuel are broken up due to the forced molecular interactions during combustion, these interactions induce ionization of the fuel molecule “fragments.” Second, when high thermal conditions associated with combustion cause thermal ionization of the gases present in the combustion chamber during combustion ionization is increased. Therefore, combustion results in an increase in ions within the combustion chamber when compared to the level of ionization within the combustion chamber prior to combustion.

As previously mentioned, a threshold is determined with an initial ion gap sensing performed before the first ignition spark of a multi-spark event. As such, the ion concentration within the combustion chamber should then be at a relatively low level causing a relatively low current induced between the pair of electrodes 45 or 47. After the initial ion gap sensing and at a predetermined point in the travel of the piston 40 in the cylinder 34, fuel is injected into the combustion chamber 38 by the fuel injector 48. During stratified combustion, fuel is not injected into the combustion chamber 38 until the piston 40 is near top-dead-center (TDC), or the combustion chamber 38 is near its smallest volume. At that time, the fuel injector 48 injects a fuel spray into the cylinder thereby forming a combustion mixture with combustion supporting gas already in combustion chamber 38. The spark plug 46 is supplied with a voltage potential by the capacitor 62, which causes a spark between the pair of ignition electrodes 45. Specifically, when the fuel spray is injected into the cylinder, the ECU 22 of FIG. 2, causes the switching circuit 64, FIG. 3, to electrically connect the capacitor 62 to the spark plug 46. The capacitor 62 then discharges through the spark plug 46, thereby delivering a first ignition spark of the multi-spark event. The spark is formed between the ignition electrodes 45 to attempt ignition of the injected fuel.

Following the ignition spark, the ECU 22 of FIG. 2, again energizes a pair of electrodes, either the pair of ignition electrodes 45, FIG. 3, to perform ion gap sensing before a second ignition spark in the multi-spark event. As will be described, the ECU 22 of FIG. 2, compares the current induced in the initial threshold ion gap sensing to the current induced in the currently performed ion gap sensing. If the ECU 22 determines that a current indicative of combustion has been detected, the ECU 22 discontinues the multi-spark event causing the switching circuit 64, FIG. 3, to electrically connect the capacitor to another spark plug (not shown) disposed in another combustion chamber (not shown), or alternatively, to dump the charge to ground.

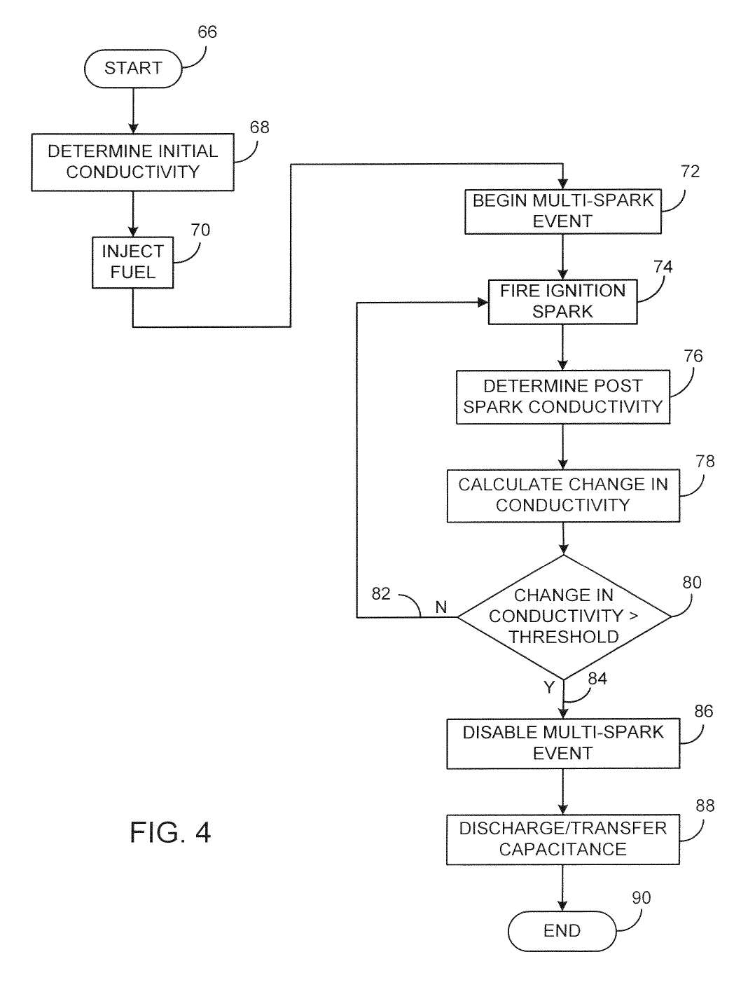

During engine operation, the piston 40 is driven, in a reciprocating manner, between a generally TDC position and a generally BDC position. Referring to FIG. 4, a flow chart acts forth the steps of an exemplary embodiment. When the piston 40, FIG. 3, is near BDC, the initial ion gap begins by energizing the pair of electrodes 66, FIG. 4. A determination of the conductivity within the combustion camber is made 68 as a baseline for comparison with later determinations of conductivity.

Following the initial determination of conductivity 68, the piston returns toward TDC at which time fuel is injected into the combustion chamber 70. Closely following fuel injection 70, a multi-spark event is initiated 72. The capacitor discharges though the spark plug causing an ignition spark 74 to fire into the combustion chamber. Following the first spark of the multi-spark event 74, post-spark determination of conductivity is made 76. This post-spark conductivity is compared to the initial conductivity determined in step 68 to calculate a change in conductivity 78. The change in conductivity is then compared to the threshold 80 to determine if there has been an increase in conductivity 84. If there has been a decrease in conductivity or an increase in conductivity less than the threshold 80, 82, then the multi-spark event continues and another ignition spark is fired 74. However, if the change in conductivity is greater than the threshold 80, 84, then the multi-spark event is disabled 86.

The threshold is a predefined limit, preferably measured in amperes, to which the ECU compares the amount of current detected between the electrodes. It is contemplated that a range of thresholds may be defined such that the ECU selects the appropriate threshold according to the current operating conditions of the engine. As such, a map may be used to store the thresholds and corresponding operating conditions. It is further contemplated that the ECU determine operating conditions and associated thresholds on-the-fly, or in each cycle, without the use of a map. Under this scenario, the ECU is free to select the appropriate threshold in real-time without consulting a map.

In the interim, between firing the ignition spark 76 and disabling the multi-spark event 86, the capacitor 62, FIG. 3, will have been recharged so that if not discontinued, the multi-spark event can continue. As such, in one embodiment, the capacitor 62 is discharged once more through the spark plug 46, to dump the remaining charge 88, FIG. 4. As such, the firing sequence for the cylinder concludes 90.

In an alternative embodiment, rather than discharging the charged capacitor into an empty combustion chamber, the switching circuit 64, FIG. 3, is used to electrically connect the capacitor 62 to an adjacent cylinder that is preparing to begin the combustion sequence. Specifically, high voltage field effect transistors (FETs) switch the capacitor 62 to the adjacent cylinder such that the capacitor discharges through the spark plug of the adjacent cylinder 88, FIG. 4. As such, following the disabling of a multi-spark event within one cylinder 86, the stored charge is not dumped but instead is transferred 88 to be utilized in a multi-spark event in an another cylinder and the firing sequence for the cylinder concludes 90.

As such a technique to reduce the wear on spark plugs within a multi-spark engine is achieved. Specifically, an ECU determines the current between a pair of electrodes within a combustion chamber of a combustion engine prior to the initiation of a multi-spark event. Then, following the initiation of the multi-spark event, the ECU discontinues the multi-spark event if an increase in current between the electrodes, caused by an increase in ion concentration within the combustion chamber indicative of combustion, is detected. As such, the ECU stops firing the spark plug and avoids unnecessarily firing after combustion has occurred and the operational lifetime of the spark plug is thereby extended.

It is contemplated that the above-described technique be embodied in a system for controlling an ignition system that includes an ECU equipped engine having at least one combustion chamber, and a spark plug in operable association with the combustion chamber to allow a multi-spark event. The ECU is configured to commence the multi-spark event, detect combustion, and discontinue the multi-spark event when a certain level of ionization is detected in the at least one combustion chamber.

It is contemplated that the above-described technique be embodied in a method of controlling a multi-spark ignition system that includes determining a first ion concentration within a combustion chamber and then begin firing an ignition spark of a multi-spark event into the combustion chamber. The method includes monitoring subsequent ion concentration within the combustion chamber and disabling subsequent ignition sparks of the multi-spark event if a difference between the first and subsequent ion concentrations is indicative of a fuel ignition.

It is contemplated that the above-described technique be embodied in a combustion engine that includes a powerhead having a combustion engine, a midsection configured for mounting the outboard motor to a watercraft, and a lower unit powered by the engine to propel the watercraft. The combustion engine also includes at least one combustion chamber and at least one spark plug to execute a multi-spark event. A pair of electrodes are also disposed within the at least one combustion chamber. An ECU is configured to commence the multi-spark event by repeatedly sparking the spark plug and discontinue the multi-spark event if a current indicative of combustion between the pair of electrodes within the combustion chamber is during the multi-spark event.

The present invention has been described in terms of the preferred embodiment, and it is recognized that equivalents, alternatives, and modifications, aside from those expressly stated, are possible and within the scope of the appending claims.

1. A system for controlling an ignition system comprising:
an engine having at least one combustion chamber;
a spark plug disposed within the at least one combustion chamber; and
an engine control unit (ECU) configured to commence a multi-spark event of the spark plug, detect combustion, and discontinue the multi-spark event upon detection of combustion in the at least one combustion chamber.

2. The system of claim 1 wherein the ECU is further configured to compare a current between a pair of electrodes disposed within the combustion chamber before the execution of the multi-spark event and a current between the pair of electrodes after an execution of the multi-spark event to detect a conductivity indicative of combustion.

3. The system of claim 2 wherein the conductivity indicative of combustion is detected if the current between the pair of electrodes after the execution of the multi-spark event is greater than the current between the pair of electrodes before an execution of the multi-spark event.

4. The system of claim 2 wherein the ECU is further configured to allow the spark plug to execute the multi-spark event until one of the current indicative of combustion is detected between the pair of electrodes and a predetermined duration of the multi-spark event has expired.

5. The system of claim 1 wherein the ECU is configured to discontinue the multi-spark event if the conductivity detected is indicative of an increase in ion concentration within the combustion chamber.

6. The system of claim 1 further comprising a capacitor to a store a voltage potential, wherein the capacitor is configured to deliver a stored voltage potential to supply the spark plug with a voltage potential to execute the multi-spark event.

7. The system of claim 6 wherein the system is further configured to dump a remaining stored voltage potential after the ECU discontinues the multi-spark event.

8. The system of claim 6 further comprising a switching circuit configured to discharge the stored voltage potential for a first combustion chamber to a spark plug of another combustion chamber after the ECU discontinues the multi-spark event in the first combustion chamber.

9. The system of claim 8 wherein the switching circuit is further configured to switch delivery of the stored voltage potential while the capacitor is charged with the stored voltage potential.

10. The system of claim 1 wherein the ECU is further configured to execute the multi-spark event during a stratified combustion mode in the combustion chamber.

11. The system of claim 1 incorporated into one of an outboard motor, an inboard motor, an all terrain vehicle engine, a motorcycle engine, a scooter engine, a snowmobile engine, and a lawn equipment engine.

12. The system of claim 2 wherein the pair of electrodes is a pair of spark plug electrodes.

13. The system of claim 2 wherein the pair of electrodes is independent of a pair of spark plug electrodes.

14. A method of controlling a multi-spark ignition system comprising the steps of:
(A) determining a first ion concentration within a combustion chamber of a marine engine;
(B) firing an ignition spark of a multi-spark event into the combustion chamber;
(C) monitoring subsequent ion concentration within the combustion chamber; and
(D) disabling subsequent ignition sparks of the multi-spark event if the ion concentration within the combustion chamber is indicative of a fuel ignition, otherwise repeating steps (B) through (C).

15. The method of claim 14 further comprising the step of discharging a stored voltage potential to cause the firing of the ignition spark.

16. The method of claim 14 further comprising the step of discharging a stored voltage potential from a capacitor to another combustion chamber if the ion concentration within the combustion chamber is indicative of fuel ignition.

17. The method of claim 14 wherein monitoring an ion concentration comprises the step of determining a current induced by a voltage potential between a pair of electrodes.

18. The method of claim 17 wherein an increase in the current induced by the voltage potential between the pair of electrodes is indicative of fuel ignition within the combustion chamber.

19. An outboard motor comprising:
a powerhead having an internal combustion engine, a midsection configured for mounting the outboard motor to a watercraft, and a lower unit powered by the internal combustion engine to propel a watercraft, the engine having at least one combustion chamber;
at least one spark plug operationally disposed within the at least one combustion chamber to execute a multi-spark event;
a pair of electrodes disposed within the at least one combustion chamber and having a voltage potential therebetween; and
an ECU configured to commence the multi-spark event by repeatedly sparking the spark plug and discontinue the multi-spark event if a current indicative of combustion between the pair of electrodes within the combustion chamber is detected during the multi-spark event.

20. The outboard motor of claim 19 wherein the ECU determines a first current prior to the multi-spark event and a second current during execution of the multi-spark event, and wherein if the second current is greater than the first current, the ECU indicates a conductivity indicative of combustion.

21. The outboard motor of claim 20 wherein the second current induced during the multi-spark event is induced between ignition sparks of the multi-spark event.

22. The outboard motor of claim 20 wherein the pair of electrodes is a pair of auxiliary electrodes.

23. The outboard motor of claim 20 wherein the at least one spark plug includes the pair of electrodes.

24. The outboard motor of claim 19 wherein the engine further comprises a storage device to supply the at least one spark plug with a voltage potential to execute the multi-spark event and a switching circuit to transfer an output of the storage device to at least one other spark plug disposed in at least one other combustion chamber when the multi-spark event is discontinued.

25. The outboard motor of claim 21 wherein the conductivity indicative of combustion is detected if the second current is greater than the first current by greater than a threshold value.
